(19) United States
(12) Patent Application Publication
(10) Pub. No.: US 2014/0279388 A1
(43) Pub. Date: Sep. 18, 2014

(54) METHOD, APPARATUS, AND COMPUTER-READABLE MEDIUM FOR ADVANCING PREPAID CREDIT

(71) Applicant: MOBILE DECISIONING HOLDINGS LIMITED, Nairobi (KE)

(72) Inventors: Josphat K. Kinyua, Johannesburg (ZA); Martin Nzioki, Nairobi (KE); Julian N. Kyula, Nairobi (KE)

(73) Assignee: MOBILE DECISIONING HOLDINGS LIMITED, Nairobi (KE)

(21) Appl. No.: 13/840,560

(22) Filed: Mar. 15, 2013

(51) Int. Cl. G06Q 40/02; G06Q 20/28

(52) U.S. Cl. CPC G06Q 40/025; G06Q 20/28
USPC 705/38

(57) ABSTRACT

An apparatus, computer-readable medium, and computer-implemented method for advancing prepaid credit includes receiving a request for an advance of prepaid credit from a subscriber, the subscriber having a subscriber account with a prepaid service provider, determining whether the subscriber is eligible for an advance based at least in part on an assessment of historical data relating to the subscriber account, and authorizing a transfer of prepaid credit from a lender account to the subscriber account based at least in part on a determination that the subscriber is eligible for an advance of prepaid credit and that sufficient prepaid credit exists in the lender account, the lender account storing prepaid credits accepted by the service provider.

### BACKGROUND

Prepaid services, i.e., services paid for in advance, are very common in certain situations. Examples of prepaid services are transit cards, pay as you go cell phones, and stored-value cards such as gift cards and preloaded credit cards. Prepaid services can include utilities, such as electrical, water, or heating services, subscription services, such as cable or internet, as well as subsets of services, such as a prepaid data packages for cell phones or prepaid airtime minutes for mobile devices.

Prepaid options can have substantial cost reductions over postpaid counterparts because they allow customers to monitor and budget usage in advance. Additionally, unlike postpaid or contract based services, prepaid accounts can be obtained with cash. As a result, they can be established by people who have minimal identification or poor credit ratings.

Depending on the prepaid service, a variety of means are used to collect payments from customers. Customers of prepaid services sometimes have to purchase a physical scratch card from a prepaid service vendor with the prepaid account information or prepaid credit codes. Additionally, customers frequently acquire prepaid credits through a point of sale (PoS) site, ATM, mobile money transfer platform, bank account linked to a money transfer platform, or a peer-to-peer transfer of prepaid credits.

The existing ways of purchasing prepaid services suffer from a number of drawbacks. In the case of physical scratch cards or PoS locations, it can be difficult for a customer to purchase additional prepaid credits at all times of the day, or all days of the week, depending on the hours of PoS location. Mobile money transfer platforms often require that a subscriber have funds immediately available at the time of purchase in order to purchase the prepaid credits or can require that the prepaid account be linked to a bank account that has credit or money.

Existing prepaid credit advance systems, such as SimKredit™ from Simbrella/Urbis Telecom (described in European Patent Publication EP 2184708), purchase the prepaid credits from the service provider before adding them to the customer's account, increasing the amount of time the customer has to wait to access the prepaid credits and forcing the customer to go without service until the payment transaction has been processed, up to five hours until the transaction is confirmed. Additionally, if there are problems with the payment transaction and it does not go through, the customer is left without service when they need it.

SimKredit™ determines eligibility for an advance in a prepaid phone account based solely on whether the requestor has an outstanding debt in that same account. This system uses text logs received from service providers to determine outstanding debt. Such logs are frequently unreliable.

### BRIEF DESCRIPTION OF THE DRAWINGS

FIG. 1 illustrates a flowchart for advancing prepaid credit according to an exemplary embodiment.

FIG. 2 illustrates a flowchart for determining whether the subscriber is eligible for an advance according to an exemplary embodiment

FIG. 3 illustrates a flowchart for determining a maximum amount of prepaid credit that a subscriber is eligible for according to an exemplary embodiment

FIG. 4 illustrates another flowchart for determining a maximum amount of prepaid credit that a subscriber is eligible for according to an exemplary embodiment

FIG. 5 illustrates a flowchart for recovery of advances according to an exemplary embodiment.

FIG. 6 illustrates a flowchart for determining whether a recovery-initiating event has occurred according to an exemplary embodiment.

FIG. 7 illustrates a flowchart for determining whether a recovery-initiating event has occurred based on a lapse in a grace period according to an exemplary embodiment.

FIG. 8 illustrates a flowchart for determining the grace period associated with a subscriber.

FIG. 9 illustrates an exemplary computing environment that can be used to carry out the method for managing mobile payment transactions according to an exemplary embodiment.

### DETAILED DESCRIPTION

While methods, apparatuses, and computer-readable media are described herein by way of examples and embodiments, those skilled in the art recognize that methods, apparatuses, and computer-readable media for advancing prepaid credit are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “can” is used in a permissive sense (i.e., meaning having the potential to) rather than the mandatory sense (i.e., meaning must). Similarly, the words “include,” “including,” and “includes” mean including, but not limited to.

Applicants have discovered a system for advancing prepaid credit which is able to provide a subscriber with access to prepaid credit anytime and anywhere the need for the service can arise. Additionally, the system for advancing prepaid credit disclosed herein avoids costly transaction processing delays by crediting subscriber accounts directly from a lender account.

FIG. 1 illustrates a flowchart for advancing prepaid credit according to an exemplary embodiment. At step 101 a request for an advance of prepaid credit is received from the subscriber. The prepaid credit request can be for an account that the subscriber has with a prepaid service provider, such as a telecommunications provider, electrical or other utilities provider, cable or internet provider, or any other service provider. Additionally, the prepaid credit can be represented in units selected or created by the prepaid service provider, or can be in a currency unit which corresponds to certain quantity of the prepaid service.

The request can be received at an Application Service (AS). The AS can be a computer system or software system that accepts, validates and processes requests for advances from subscribers on the prepaid service. The AS can interact (such as by client-server communication over TCP/UDP) with subscriber facing computers of the prepaid service provider that have a connection to the subscribers through the subscriber's device.

The request can be sent by the subscriber using any suitable communication device. For example, the subscriber can utilize a computing device, such as a laptop, or a mobile device, such as a cell phone, to make the request. The format of the request can depend on the network and configuration of the subscriber device.

For example, a subscriber who is using a mobile device that is on a Global System for Mobile (GSM) Communications network can use an Unstructured Supplementary Service Data (USSD) menu for requesting an advance of prepaid credit. The subscriber can be presented with one or more menus and sub-menus and select an option that reflects their current needs. For example, a menu can offer them options to advance airtime credits, advance data bundle credits, advance power credits, advance television credits, view a help menu, and/or change the preferred language. Each of those options in turn can present additional sub-menus, for example, and amount of prepaid credit that they would like to request, or an amount of prepaid credit that is available to them to request. Subscribers can be presented with different advance amounts that are available to them and make a selection from the available advance amounts. Subscribers can also utilize shortcuts to access different advance services or amounts. For example, a subscriber can enter some combination of the asterisk and pound keys to go directly to advance airtime credits, or enter another shortcut such as “*1#100” to automatically request a prepaid airtime credit of 100 minutes.

A subscriber that is on a Code Division Multiple Access (CDMA) network can use Short Message Service (SMS) to request an advance of prepaid credit. The options that are available via SMS can be the same ones as are available through the USSD menu, and subscribers can send special keywords to a predetermined number specified by the lender in order to request advances. For example, a subscriber can send “Airtime 100” to request an airtime advance of 100 minutes, “100 GB” to request a data bundle of 100 Gigabytes, or “1Kwh” to request a prepaid electricity credit. Of course, many variations are possible, and these examples are not intended to be limiting.

Additionally, the subscriber can request prepaid credits for a particular dedicated account or subaccount. For example, the subscriber's prepaid airtime minutes can be divided into international calls and domestic calls. Although the subscriber can have domestic credits available, they can be short on prepaid international calling credits and wish to request an advance for only the international sub-account of their prepaid service account.

The subscriber can also transmit a command which is received by the AS of the lender that enrolls the subscriber in an automated lending process. For example, a subscriber can desire to keep the balance of prepaid credits in their account at a minimum threshold. They can transmit a request indicating that they wish to enroll in automated lending to the AS using one of the above described methods, such as through the USSD menu or an SMS. For example, they can text “auto-lending 40 minutes,” which can indicate that their prepaid account balance should be kept at 40 minutes.

At step 102 it is determined whether the subscriber is eligible for an advance based at least in part on an assessment of historical data relating to the subscriber's account with the service provider. Additionally, the amount of the advance that the subscriber is eligible for can also be determined using the historical data relating to the subscriber's account with the service provider and the subscriber's history with the lender. Factors that are used to determine whether the subscriber is eligible for an advance can include historical data relating to the subscriber account, such as their prepaid credit history, their prepaid credit usage history, patterns of activity, whether their service device is registered, the frequency with which prepaid credits are added to their account, the age of the subscriber's account, and/or the amount of time since prepaid credits were added to the subscriber's account.

Additionally, determining whether the subscriber is eligible for an advance can include checking whether the subscriber has exceeded a maximum allowable advance amount, whether the subscriber currently owes prepaid credits to the lender, whether subscriber is on a black-list (prohibited from using the lender's services), whether the subscriber's credit profile, credit score, or a customized subscriber score generated by the lender are above a predetermined threshold.

If the subscriber is not eligible for an advance, or if the amount of the advance requested exceeds an amount that they are eligible for, the request can be denied at step 103. In the event that the subscriber is eligible for an amount less than they requested, they can be asked whether they would like to request the lower amount, or the request can be processed as if they had requested the lower amount.

If the user is eligible for the advance, a determination is made at step 103 regarding whether there is sufficient prepaid credit in the lender account to cover the advance. The lender account can be an account on the service provider network which is managed by the service provider, or can be a separate online wallet-type system which interfaces with and is also managed by the service provider. The lender account can be managed by Virtual Top-up Service (“V-Top”). This can be a computer system and software system that mediates requests from the AS on behalf of subscribers of the prepaid service with the prepaid service provider's charging system or payment system. This component can connect with the AS and a charging system or payment gateway through a client/server network and over TCP/UDP based protocols. This component can also manage inventory in the form of prepaid credits which are utilized in the prepaid service provider's network and can be accessible (through the web or other appropriate interface, such as a management program) administratively by the prepaid service provider and/or by the lender. For example, the service provider or the lender can access the V-Top to monitor prepaid credit usage or replenish inventory of prepaid credits.

If there is not sufficient prepaid credit in the lender account, then the request can be denied at step 103. Additionally, a message or alert can be sent to the lender regarding a low balance in the lender account. If there is sufficient prepaid credit in the lender account, then at step 105 a transfer of prepaid credit from the lender account to the subscriber account can be authorized. Since the lender account stores prepaid credits that are accepted by the service provider, there is no need to purchase the credits from the service provider before transfer. This saves transaction processing times and ensures that the subscriber receives the advance of prepaid credits right away. Additionally, a profile or data structure associated with the subscriber can be updated to reflect the amount advanced, and the subscriber can be added to a debtors list.

Additionally, the V-Top and lender account enable the lender to credit dedicated accounts or sub-accounts directly. Using the earlier example of a subscriber who requests prepaid credits for their international sub-account, the lender can authorize a transfer of prepaid credit from the international sub-account on the lender's account to the international sub-account on the subscriber's account. A subaccount menu can also be presented to the subscriber as part of the request processing, and the subscriber can then select a subaccount for the request.

The determination regarding whether a subscriber is eligible for an advance can be made by a Decision System (DS). The DS can be a computer system and software system that collects information about the subscribers on the prepaid network, including historical data, for the purposes of determining which subscribers can access the advance service and the amount of the prepaid credit advances that are available to the subscribers who can access the service.

Referring to FIG. 2, a flowchart is shown for determining whether the subscriber is eligible for an advance according to an exemplary embodiment. At step 201, a maximum amount of prepaid credit that the subscriber is eligible to be advanced is determined based on an assessment of historical data relating to the subscriber account. This step is described in greater detail further below.

At step 202, an amount of prepaid credit currently owed by the subscriber is determined. This can be based on previous advances made to the subscriber that have not been repaid. At step 203, a determination is made regarding whether the maximum amount of prepaid credit available to the subscriber is greater than the amount of prepaid credit they currently owe the lender. If the maximum amount is not greater than the amount currently owed, then a determination is made at step 204 that the subscriber is to not eligible for an advance. Of course, in situations where prepaid credits are only available in discrete quantities, this step can include the situation where the difference between the maximum amount and the amount currently owed is not greater than the amount of the lowest discrete quantity of prepaid credits available. For example, if a subscriber has a maximum amount of 100 minutes, and currently owes 98 minutes, but the prepaid minutes can only be acquired in units of 5, then the subscriber will not be eligible for an advance.

At step 205, a determination is made that the subscriber qualifies for an advance of a predetermined quantity of prepaid credit if the maximum amount of prepaid credit is greater than the amount of prepaid credit that is currently owed and the difference between the maximum amount of prepaid credit and the amount of prepaid credit that is currently owed is greater than a minimum advance amount. This minimum advance amount can be the lowest unit prepaid credit that the lender is willing to advance.

Referring to FIG. 3, a flowchart is shown for determining a maximum amount of prepaid credit that a subscriber is eligible for according to an exemplary embodiment. At step 301, an age of the subscriber account is determined. This can be how long the subscriber has had an account with the prepaid service provider. Additionally, this can also factor in how long the subscriber has been using the lender's services.

At step 302, an average amount of prepaid credits that the subscriber consumes over a predetermined time period is determined. This average consumption value can be determined for any unit of time, depending on the lender's preferences. For example, the average consumption can be per month, per year, per week, or per day. At step 303, an average number of times that the subscriber purchased prepaid credits over the predetermined time period can be determined to generate a subscriber average refill value.

At step 304, the subscriber can be assigned to a maximum amount tier from a plurality of maximum amount tiers based on the age, average consumption, and average refill values. Of course, the subscriber does not have to be assigned to a tier, and a maximum prepaid credit advance amount can be computed for each subscriber using a suitable algorithm or heuristic. However, for simplicity and marketing reasons, discrete bands or tiers of maximum amounts are preferable, as subscribers can easily determine how many prepaid credits they are eligible to be advanced based on their particular circumstances.

The table below shows an example of an assignment table for assigning subscribers to maximum amount tiers:

TABLE 1
Assignment of subscribers to maximum amount tiers

| Max Amount of | | | |
|---|---|---|---|
| prepaid credits | Qualifying criteria | | |
| to be advanced | Minimum | Minimum average | Minimum average |
| (in dollars) | age value | monthly consumption | refills per month |
| $1 | 3 months | $4 | 3 |
| $2 | 4 months | $10 | 4 |
| $3 | 6 months | $18 | 5 |
| $4 | 9 months | $30 | 5 |

As the table above shows, the subscribers can be grouped into tiers based on minimum qualifying values for each of subscriber account age, average monthly consumption, and average refills per month. Qualifying subscribers can be required to fit into a specific tier. In other words, for a subscriber to qualify for a specific amount, they can be required to qualify based on all criteria. The tier that they fit in can be determined by the lowest band they qualify for on all criteria. So if a subscriber fails to qualify for a tier on any one criterion, they can be deemed to fail to qualify for the tier. For example, if a subscriber had an account age of 6 months, averaged 4 refills per month, and an average monthly consumption of $6, then they would only qualify for the lowest tier, which is a maximum advance amount of prepaid credits equal to $1.

The determination of the amounts to be advanced and the threshold for each qualifying criteria is based on a combination of a qualitative and quantitative analysis that take into account market specific circumstances, such as gross margin, and the costs and benefits associated with taking risks.

The amount to be advanced can be based on the service provider's Average Revenue Per User (ARPU). Through statistical analysis, applicants have determined that the median amount advanced preferably should equate to 25-30% of the ARPU. Applicants have also determined that the optimal range of amounts is between 10% and 50% of ARPU. For example if Verizon™ customers ARPU is $20 per month, the median amount that will be in the range of maximum advance amounts can be $5 and the range can be between $2 and $10.

The number of tiers can be determined by the lender as well. The number of tiers can be based on marketing considerations and simplicity for subscribers and can balance having variety and not creating too much choice that the subscriber is confused. Market specific factors like quality of distribution infrastructure can also influence the number of tiers.

Statistically, there is a direct inverse correlation between age of the subscriber account and the risk of default. The longer a customer is associated with a particular account, or a particular service, the more dependent they are. Accordingly, a lender's preferences with regards to age of subscriber accounts can be determined by a qualitative assessment of competitive dynamics and margins available to absorb loses.

Minimum average consumption can also be customized by the lender depending on specific market conditions, such as the fee structure or profit margin of the lender. For example, a lender can negotiate for a percentage of revenue with a prepaid services provider from prepaid services advanced by the lender, and then base their overall strategy and risk levels upon that percentage. For example, a lender can use a gross margin value to determine that a subscriber should be spending three times as much on prepaid credits as the maximum amount they should be advanced, in order to balance risk with profit.

With regard to average refills, every refill event represents an opportunity to recover an amount advanced. Accordingly, the minimum average refill value is more important in competitive markets where there is a propensity to switch between service providers, which leads to a default of the amount owed to the lender. The ability to vary or use the minimum average refill value can be dependent on the gross margin the lender earns and the qualitative assessment of the competitive dynamics in the market. The lender can reduce this criterion if gross margins are higher and vice versa.

Of course, these parameters are not the only parameters than can be used when determining a maximum amount of prepaid credit that a subscriber is eligible for. Referring to FIG. 4, a flowchart is shown for determining a maximum amount of prepaid credit that a subscriber is eligible for according to an exemplary embodiment. Steps 401, 402, and 403 are similar to the steps 301, 302, and 303 shown in FIG. 3, in that an age of the subscriber account is determined, a subscriber average consumption value is determined, and a subscriber average refills value is determined.

Additionally, in step 404, a subscriber inactivity value is determined. This can be the amount of time that has passed since the subscriber last purchased prepaid credits or otherwise generated revenue for the service provider or lender. This criterion can establish how active a subscriber is. Averages can mask recent activity and can be misleading because the subscriber's circumstances can have changed recently. The inactivity value can be a Boolean value and can be used to block certain subscribers from receiving advances, such that if they have been inactive for too long a period of time, they will not be advanced any prepaid credits. So, for example, a subscriber can be denied an advance if they have been inactive for 30 days, regardless of the other data values associated with their account that may have qualified them for an advance. Alternatively, the inactivity value can be a quantity and can be used along with the other values to assign a subscriber to a maximum amount tier. For example, the lowest tier can specify that the subscriber must not have been inactive for the past 10 days.

Another criterion that can be used in determining the maximum amount for a subscriber is whether the subscriber has registered. For example, prepaid cell phone subscribers can register their (Subscriber Identity Module) SIM cards, which can be integrated with the mobile device. This criterion can be a binary (Boolean) criterion. The risk associated with advancing prepaid credits to an unregistered subscriber can be very high. Accordingly, in a market where registration is mandatory, this criterion can be fundamental and supersede all other criteria. In an environment where registration is not mandatory, this criterion can be qualitatively positive because the process of registration is both time consuming and costly and therefore a deterrent to switching. In those situations, subscribers who have registered their SIM card can be upgraded tiers or placed into the next eligible maximum amount tier based on their registration.

The maximum amount of prepaid credit can also depend on criteria related to a specific subaccount if a subscriber is requesting an advance for that subaccount. For example, if a subscriber is requesting an advance into the long distance subaccount of a prepaid cell phone, then the long distance subaccount can be used to determine relevant criteria, such as inactivity or average consumption.

Of course, the criteria described are provided for the purpose of explanation only, and the maximum amount of prepaid credit can be determined based on a variety of criteria and in a variety of ways, depending on the lender's preferences and market conditions.

A process for recovery of advances will now be described in greater detail. The recovery process can be carried out by a Recovery Service (RS). An RS can be a computer system and software system responsible for recovering advances from subscribers of the prepaid service by intercepting events (refills, top-ups, peer transfers, deposits, time-based events) or analyzing logs generated from the prepaid service provider's computers and software systems that are associated with the subscriber accounts as defined by the service provider. This component can also deduct any administrative fees when the results of the analysis advise the RS to do so. The component interfaces with computers and software systems on the prepaid service provider's network to effect the charges for the settlement of the advance over computer protocols such as UDP/TCP.

FIG. 5 illustrates a flowchart for recovery of advances according to an exemplary embodiment. At step 501 a determination is made whether a recovery-initiating event has occurred. These will be described in greater detail with regard to FIGS. 6 and 7. If a recovery-initiating event has not occurred, no recovery is attempted at step 502 and the RS can continue monitoring for a recovery-initiating event at step 501. If a recovery-initiating event has occurred, then a determination is made at step 503 regarding whether the amount of prepaid credit currently owed by the subscriber is greater than zero. This can be performed by comparing the subscriber to a debtors list, or by checking a data value associated with the subscriber. For example, the lender can check a subscriber profile or data structure to determine the amount of prepaid credit that is currently owed by the subscriber to the lender.

If the amount of prepaid credit currently owed by the subscriber is not greater than zero, then no recovery is attempted at step 502, since nothing is owed. Otherwise, a determination is made at step 504 of whether the amount of prepaid credit in the subscriber account is greater than zero. If it is not, then no recovery is attempted at 502, since there is nothing available in the account to recover.

When the amount of prepaid credit in the subscriber account is greater than zero, then a determination can be made regarding the amount of prepaid credit that is currently in the subscriber account. If the amount of prepaid credit in the subscriber account is greater than zero, then at step 505, a transfer of prepaid credit from the subscriber account to the lender account is authorized.

If the amount of prepaid credit that is currently owed is less than or equal to the amount of prepaid credit in the subscriber account, then the amount of prepaid credit that is currently owed is deducted from the subscriber account and authorized for transfer to the lender account, the amount currently owed by the subscriber is set to zero, and the subscriber can be removed from any debtor list. Otherwise, if the amount of prepaid credit that is currently owed is greater than the amount of prepaid credit in the subscriber account, then the balance of the prepaid credit in the subscriber account is transferred to the lender account and the current amount owed is updated.

The amount of prepaid credit that is owed can reflect any administrative or processing charges for using the advance service. Additionally, administrative or processing charges can be deducted on top of the amount of prepaid credit that is owed as part of the recovery process.

FIG. 6 illustrates a flowchart for determining whether a recovery-initiating event has occurred according to an exemplary embodiment. At step 601, an activity log relating to the subscriber account is received. Activity logs can be received by the RS from the service provider computing system. Additionally, the RS can include a decoder which is adapted to decode the logs received from service provider computing system in their native format. This eliminates the need for an intermediate system to decode the service provider logs. For example, many telecommunications companies utilize binary activity logs. The RS can have a binary log decoder built in which can decode these logs, and the lender can coordinate with the telecommunications company to customize the decoder to a service provider's specific format.

Activity logs can be received periodically or in batches. Alternatively, activity logs can be received continuously and monitored continuously. Activity logs can also be received and compiled, and then processed in batches. Many variations are possible and these examples are not intended to be limiting.

At step 602 a determination is made regarding whether additional prepaid credit has been added to the account based on the activity logs. This can include events such as the subscriber purchasing additional prepaid credits from the service provider, a second subscriber transferring prepaid credits to the subscriber, or the subscriber having some prepaid credits automatically added to their account in accordance with an agreement with the service provider.

Regardless of how the additional prepaid credits are added to the account, if additional prepaid credits have been added, then a determination is made at step 604 that a recovery-initiating event occurred. If additional prepaid credits have not been added, then a determination is made at step 603 that a recovery initiating event has not occurred. The process is then repeated starting at step 601.

The RS can also monitor logs to determine when to automatically advance a prepaid credit to a subscriber if the subscriber is enrolled in an automated lending program. For example, the activity logs can be analyzed to determine when the subscriber's balance has fallen below a predetermined threshold. When this is detected, an advance request can automatically be triggered on behalf of the subscriber to add prepaid credits to the subscriber account so that the amount of prepaid credits equals the predetermined threshold. The predetermined threshold can be a minimum number of prepaid credits specified by the subscriber.

In certain situations, activity logs are not reliable indicators of when a recovery-initiating event has occurred. For example, there can be delays in the receipt of activity logs, or activity logs that are received can be incomplete or corrupted. FIG. 7 illustrates a flowchart for determining whether a recovery-initiating event has occurred based on a lapse in a grace period according to an exemplary embodiment. At step 701, a determination is made regarding the period of time that has passed since the transfer of prepaid credit from the lender account to the subscriber account. At step 702, a determination is made regarding whether the period of time that has passed is greater than a grace period associated with the subscriber. If the period of time that has passed is greater than the grace period, then a determination is made at step 704 that a recovery-initiating event occurred. Otherwise, if the period of time that has passed is not greater than the grace period, then a determination is made at step 703 that a recovery-initiating event has not occurred.

FIG. 8 illustrates a flowchart for determining the grace period associated with a subscriber. At step 801 subscriber activity is extracted from activity logs. The subscriber activity can include usage data and time data, as well as refill data such as when additional prepaid credits have been added to the subscriber account. This can include events such as the subscriber purchasing additional prepaid credits from the service provider, a second subscriber transferring prepaid credits to the subscriber, or the subscriber having some prepaid credits automatically added to their account in accordance with an agreement with the service provider. Activity can also include times heavy usage, frequency of refills, or any other historical data relating to the usage or addition of prepaid credits to the subscriber's account.

At step 802, a pattern of prepaid credit additions is determined based on the subscriber activity data. This can be determined by analyzing the dates and times of additions of prepaid credits to the subscriber's account. The pattern can include the prepaid credit addition times, the prepaid credit addition frequency, the prepaid credit addition amounts or average amounts, or any other data relating to patterns of usage or additions. The pattern identification is useful for determining customer behavior and estimating when a subscriber is most likely to add prepaid credits to their account, or have prepaid credits transferred to their account by others.

The pattern of prepaid credit additions is then used at step 803 to calculate a grace period for the subscriber. For example, a pattern can indicate that a particular subscriber only adds credits to their account once every 10 days, and this knowledge can be leveraged to calculate a grace period of 5 days for the subscriber.

Another example can be if the pattern indicated that the subscriber only adds credits to their account at the end of the month. In this situation, a dynamic grace period can be calculated for the subscriber. The dynamic grace period can be dependent on the time of the month when the subscriber received the advance, and could be represented as an equation. For example, the grace period can be:

$$\frac{\vert \begin{matrix}( avg . days in a month ) - \\ ( day of the month when advance granted )\end{matrix} \vert}{2}$$

So if the subscriber were to receive an advance on the 16th, and the average days in a month are 30, then the grace period would be (130-161)/2=7 days. Of course, this equation is just provided as an example of one of the many ways in which the subscriber activity data and prepaid credit additions can be leveraged to calculate a grace period.

By calculating a grace period the RS can strategically determine when to attempt a recovery of any advance, and accordingly avoid unnecessary processing and overhead due to failed attempts to recover prepaid credits from the subscriber account when there are no prepaid credits available in the subscriber's account.

Computing systems than can be used to implement the techniques disclosed herein are described below.

Business Support Systems, which can be computer systems and software systems running dedicated services that support the operations described herein. These software systems generate intelligence reports on usage of the prepaid service subscribers and also provide web access to the prepaid service provider to investigate and resolve subscriber complaints and inquiries.

A Reconciliation Service, which can be a software system and computer system that automatically investigates failed advance requests or advance requests whose success status is unconfirmed (because of network communication errors, or data inconsistencies or multiple data source conflicts) and automatically adjusts the advance transactions to their correct state. Failed transactions can have succeeded and vice versa, this component ensures no revenue loss or unfair revenue gain due leaving the data in a consistent verifiable state.

A Logging and Audit Trail Service, which can be a computer and software system that is responsible for logging (recording, annotating) all events (occurrences of interest to the system that include but are not limited to network communication failures, computer resource usage (RAM, CPU, Disk Space), software health metrics (uptime, responsiveness, transactions per second)) that pertain to the system.

A Charging System, which can be a software system that maintains the digital representation of the subscriber's account and account details relating to among other things account balance, bonus accounts, subsidiary accounts, subscriber preferences (language, location). This component can contain application programming interfaces (API) that the lender systems use to grant advances or process subsequent deductions.

A Payment Gateway, which can be a software system and set of computers that acts as an intermediary between the Charging System and third party software systems like the lender system. These can be deployed by prepaid service providers for fraud control, security and extensibility (e.g. ability to sell prepaid credits from ATMs) reasons. They can expose APIs similar to those of the charging system.

A USSD Gateway, which can be a software system that handles interaction between subscriber requests on a GSM or CDMA mobile network and lender systems. This component can forward incoming digital requests from the subscribers to the lender's advance systems. The gateway can achieve this interaction by converting the subscriber requests to XML-RPC, HTTP, JSON, SMPP or any other formats that can be consumed by lender system. This system can also relay back the responses from the lender system to the subscriber on the network. The lender system can use this system to collect subscriber requests.

A Multi Mediation Service can be a computer software system which converges all events (Terminating Calls, Originating Calls, Refills, Lifecycle Changes, Balance Adjustments, Purchases, Peer Transfers, Time based events) logs from all the nodes (composite software systems and digital computers) of the entire system. This system can accept rules to forward incoming log files to certain interested systems and parties. The lender system can receive log files from this system for purposes of event triggered recoveries.

An SMSC is a Short Message Service Center that can be implemented by the GSM/CDMA service providers for the purpose of sending and receiving Short Message Services on their networks. The lender system can connect over computer networks to this service to send messages relating to system usage to subscribers of the prepaid service providers.

A Data Warehouse System, which can be a software system and computers of the prepaid service provider that can collect various information regarding the subscribers and their usage of the prepaid service and can include usage history, refill history, balance history, and/or relationship to other subscribers. The Data Warehouse System can send digital records of these data sets to the Decision System for purposes of analysis and scoring.

FIG. 9 illustrates a generalized example of a computing environment 900. The computing environment 900 is not intended to suggest any limitation as to scope of use or functionality of a described embodiment.

With reference to FIG. 9, the computing environment 900 includes at least one processing unit 910 and memory 920. The processing unit 910 executes computer-executable instructions and can be a real or a virtual processor. In a multi-processing system, multiple processing units execute computer-executable instructions to increase processing power. The memory 920 can be volatile memory (e.g., registers, cache, RAM), non-volatile memory (e.g., ROM, EEPROM, flash memory, etc.), or some combination of the two. The memory 920 can store software instructions 980 for implementing the described techniques when executed by one or more processors. Memory 920 can be one memory device or multiple memory devices.

A computing environment can have additional features. For example, the computing environment 900 includes storage 940, one or more input devices 950, one or more output devices 960, and one or more communication connections 990. An interconnection mechanism 970, such as a bus, controller, or network interconnects the components of the computing environment 900. Typically, operating system software or firmware (not shown) provides an operating environment for other software executing in the computing environment 900, and coordinates activities of the components of the computing environment 900.

The storage 940 can be removable or non-removable, and includes magnetic disks, magnetic tapes or cassettes, CD-ROMs, CD-RWs, DVDs, or any other medium which can be used to store information and which can be accessed within the computing environment 900. The storage 940 can store instructions for the software 980.

The input device(s) 950 can be a touch input device such as a keyboard, mouse, pen, trackball, touch screen, or game controller, a voice input device, a scanning device, a digital camera, remote control, or another device that provides input to the computing environment 900. The output device(s) 960 can be a display, television, monitor, printer, speaker, or another device that provides output from the computing environment 900.

The communication connection(s) 990 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 900, computer-readable media include memory 920, storage 940, communication media, and combinations of any of the above.

Of course, FIG. 9 illustrates computing environment 900, display device 960, and input device 950 as separate devices for ease of identification only. Computing environment 900, display device 960, and input device 950 can be separate devices (e.g., a personal computer connected by wires to a monitor and mouse), can be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 900 can be a set-top box, mobile device, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments can be used with or perform operations in accordance with the teachings described herein. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

What is claimed is:

1. A method for advancing prepaid credit executed by one or more computing devices, the method comprising:
receiving, by at least one of the one or more computing devices, a request for an advance of prepaid credit from a subscriber, wherein the subscriber has a subscriber account with a prepaid service provider;
determining, by at least one of the one or more computing devices, whether the subscriber is eligible for an advance based at least in part on an assessment of historical data relating to the subscriber account; and
authorizing, by at least one of the one or more computing devices, a transfer of prepaid credit from a lender account to the subscriber account based at least in part on a determination that the subscriber is eligible for an advance of prepaid credit and that sufficient prepaid credit exists in the lender account, wherein the lender account stores prepaid credits accepted by the service provider.

2. The method of advancing prepaid credit of claim 1, wherein determining whether the subscriber is eligible for an advance based at least in part on an assessment of historical data relating to the subscriber account comprises:
determining a maximum amount of prepaid credit that the subscriber is eligible to be advanced based on an assessment of historical data relating to the subscriber account;
determining an amount of prepaid credit that is currently owed by the subscriber from one or more previous advances; and
determining that the subscriber qualifies for an advance of a predetermined quantity of prepaid credit, based at least in part on an assessment that the maximum amount of prepaid credit is greater than the amount of prepaid credit that is currently owed and that the difference between the maximum amount of prepaid credit and the amount of prepaid credit that is currently owed is greater than a minimum advance amount.

3. The method of advancing prepaid credit of claim 2, wherein determining a maximum amount of prepaid credit that the subscriber is eligible to be advanced based on an assessment of historical data relating to the subscriber account comprises:
determining the amount of time the subscriber has had the subscriber account with the prepaid service provider to generate a subscriber account age value;
determining an average amount of prepaid credits that the subscriber consumes over a predetermined time period to generate a subscriber average consumption value;
determining an average number of times that the subscriber purchased prepaid credits over the predetermined time period to generate a subscriber average refill value; and
assigning the subscriber to a maximum amount tier in a plurality of maximum amount tiers, based at least in part on the subscriber account age value, the subscriber average consumption value, and the subscriber average refill value.

4. The method of advancing prepaid credit of claim 3, wherein determining a maximum amount of prepaid credit that the subscriber is eligible to be advanced based on an assessment of historical data relating to the subscriber account further comprises:
determining an amount of time that has passed since the subscriber last purchased prepaid credits to generate a subscriber inactivity value; and
assigning the subscriber to a maximum amount tier in a plurality of maximum amount tiers, based at least in part on the subscriber account age value, the subscriber average consumption value, the subscriber average refill value, and the subscriber inactivity value.

5. The method of advancing prepaid credit of claim 1, wherein historical data relating to the subscriber account comprises at least one of subscriber advance repayment history, subscriber prepaid credit purchase history, subscriber prepaid credit usage history, and subscriber registration.

6. The method of advancing prepaid credit of claim 1, further comprising:
determining, by at least one of the one or more computing devices, whether a recovery-initiating event has occurred;
determining, by at least one of the one or more computing devices, an amount of prepaid credit that is currently owed by the subscriber based at least in part on a determination that a recovery-initiating event has occurred;
determining, by at least one of the one or more computing devices, an amount of prepaid credit that is currently in the subscriber account based at least in part on a determination that a recovery-initiating event has occurred and that the amount of prepaid credit that is currently owed by the subscriber is greater than zero; and
authorizing, by at least one of the one or more computing devices, a transfer of prepaid credit from the subscriber account to the lender account based at least in part on a determination that a recovery-initiating event has occurred, that the amount of prepaid credit that is currently owed by the subscriber is greater than zero, and that the amount of prepaid credit that is currently in the subscriber account is greater than zero.

7. The method of advancing prepaid credit of claim 6, wherein determining whether a recovery-initiating event has occurred comprises:
receiving an activity log relating to the subscriber account with the prepaid service provider;
determining whether additional prepaid credit has been added to the subscriber account based on the activity log; and
determining that a recovery-initiating event has occurred based at least in part on a determination that additional prepaid credit has been added to the subscriber account.

8. The method of advancing prepaid credit of claim 6, wherein determining whether a recovery-initiating event has occurred comprises:
determining a period of time that has passed since the transfer of prepaid credit from the lender account to the subscriber account; and
determining that a recovery-initiating event has occurred based on an assessment that the period of time that has passed since the transfer of prepaid credit from the lender account to the subscriber account is greater than a grace period for the subscriber, wherein the grace period for the subscriber is determined based on historical data relating to the subscriber account.

9. The method of claim 8, wherein the grace period is determined by:
extracting subscriber activity data from activity logs relating to the subscriber account with the service provider;
determining a pattern of prepaid credit additions from the subscriber activity data; and
calculating the grace period based at least in part on the pattern of prepaid credit additions.

10. An apparatus for advancing prepaid credit, the apparatus comprising:
one or more processors; and
one or more memories operatively coupled to at least one of the one or more processors and having instructions stored thereon that, when executed by at least one of the one or more processors, cause at least one of the one or more processors to:
receive a request for an advance of prepaid credit from a subscriber, wherein the subscriber has a subscriber account with a prepaid service provider;
determine whether the subscriber is eligible for an advance based at least in part on an assessment of historical data relating to the subscriber account; and
authorize, a transfer of prepaid credit from a lender account to the subscriber account based at least in part on a determination that the subscriber is eligible for an advance of prepaid credit and that sufficient prepaid credit exists in the lender account, wherein the lender account stores prepaid credits accepted by the service provider.

11. The apparatus for advancing prepaid credit of claim 10, wherein determining whether the subscriber is eligible for an advance based at least in part on an assessment of historical data relating to the subscriber account comprises:
determining a maximum amount of prepaid credit that the subscriber is eligible to be advanced based on an assessment of historical data relating to the subscriber account;
determining an amount of prepaid credit that is currently owed by the subscriber from one or more previous advances; and
determining that the subscriber qualifies for an advance of a predetermined quantity of prepaid credit, based at least in part on an assessment that the maximum amount of prepaid credit is greater than the amount of prepaid credit that is currently owed and that the difference between the maximum amount of prepaid credit and the amount of prepaid credit that is currently owed is greater than a minimum advance amount.

12. The apparatus for advancing prepaid credit of claim 11, wherein determining a maximum amount of prepaid credit that the subscriber is eligible to be advanced based on an assessment of historical data relating to the subscriber account comprises:
determining the amount of time the subscriber has had the subscriber account with the prepaid service provider to generate a subscriber account age value;
determining an average amount of prepaid credits that the subscriber consumes over a predetermined time period to generate a subscriber average consumption value;
determining an average number of times that the subscriber purchased prepaid credits over the predetermined time period to generate a subscriber average refill value; and
assigning the subscriber to a maximum amount tier in a plurality of maximum amount tiers, based at least in part on the subscriber account age value, the subscriber average consumption value, and the subscriber average refill value.

13. The apparatus for advancing prepaid credit of claim 12, wherein determining a maximum amount of prepaid credit that the subscriber is eligible to be advanced based on an assessment of historical data relating to the subscriber account further comprises:
determining an amount of time that has passed since the subscriber last purchased prepaid credits to generate a subscriber inactivity value; and
assigning the subscriber to a maximum amount tier in a plurality of maximum amount tiers, based at least in part on the subscriber account age value, the subscriber average consumption value, the subscriber average refill value, and the subscriber inactivity value.

14. The apparatus for advancing prepaid credit of claim 10, wherein historical data relating to the subscriber account comprises at least one of subscriber advance repayment history, subscriber prepaid credit purchase history, subscriber prepaid credit usage history, and subscriber registration.

15. The apparatus for advancing prepaid credit of claim 10, wherein the one or more memories have further instructions stored thereon, that, when executed by at least one of the one or more processors, cause at least one of the one or more processors to:
determine whether a recovery-initiating event has occurred;
determine an amount of prepaid credit that is currently owed by the subscriber based at least in part on a determination that a recovery-initiating event has occurred;
determine an amount of prepaid credit that is currently in the subscriber account based at least in part on a determination that a recovery-initiating event has occurred and that the amount of prepaid credit that is currently owed by the subscriber is greater than zero; and
authorize a transfer of prepaid credit from the subscriber account to the lender account based at least in part on a determination that a recovery-initiating event has occurred, that the amount of prepaid credit that is currently owed by the subscriber is greater than zero, and that the amount of prepaid credit that is currently in the subscriber account is greater than zero.

16. The apparatus for advancing prepaid credit of claim 15, wherein determining whether a recovery-initiating event has occurred comprises:
receiving an activity log relating to the subscriber account with the prepaid service provider;
determining whether additional prepaid credit has been added to the subscriber account based on the activity log; and
determining that a recovery-initiating event has occurred based at least in part on a determination that additional prepaid credit has been added to the subscriber account.

17. The apparatus for advancing prepaid credit of claim 15, wherein determining whether a recovery-initiating event has occurred comprises:
determining a period of time that has passed since the transfer of prepaid credit from the lender account to the subscriber account; and
determining that a recovery-initiating event has occurred based on an assessment that the period of time that has passed since the transfer of prepaid credit from the lender account to the subscriber account is greater than a grace period for the subscriber, wherein the grace period for the subscriber is determined based on historical data relating to the subscriber account.

18. The apparatus for advancing prepaid credit of claim 17, wherein the grace period is determined by:
extracting subscriber activity data from activity logs relating to the subscriber account with the service provider;
determining a pattern of prepaid credit additions from the subscriber activity data; and
calculating the grace period based at least in part on the pattern of prepaid credit additions.

19. At least one non-transitory computer-readable medium storing computer-readable instructions that, when executed by one or more computing devices, cause at least one of the one or more computing devices to:
receive a request for an advance of prepaid credit from a subscriber, wherein the subscriber has a subscriber account with a prepaid service provider;
determine whether the subscriber is eligible for an advance based at least in part on an assessment of historical data relating to the subscriber account; and
authorize, a transfer of prepaid credit from a lender account to the subscriber account based at least in part on a determination that the subscriber is eligible for an advance of prepaid credit and that sufficient prepaid credit exists in the lender account, wherein the lender account stores prepaid credits accepted by the service provider.

20. The at least one non-transitory computer-readable medium of claim 19, wherein determining whether the subscriber is eligible for an advance based at least in part on an assessment of historical data relating to the subscriber account comprises:
determining a maximum amount of prepaid credit that the subscriber is eligible to be advanced based on an assessment of historical data relating to the subscriber account;
determining an amount of prepaid credit that is currently owed by the subscriber from one or more previous advances; and
determining that the subscriber qualifies for an advance of a predetermined quantity of prepaid credit, based at least in part on an assessment that the maximum amount of prepaid credit is greater than the amount of prepaid credit that is currently owed and that the difference between the maximum amount of prepaid credit and the amount of prepaid credit that is currently owed is greater than a minimum advance amount.

21. The at least one non-transitory computer-readable medium of claim 20, wherein determining a maximum amount of prepaid credit that the subscriber is eligible to be advanced based on an assessment of historical data relating to the subscriber account comprises:
determining the amount of time the subscriber has had the subscriber account with the prepaid service provider to generate a subscriber account age value;
determining an average amount of prepaid credits that the subscriber consumes over a predetermined time period to generate a subscriber average consumption value;
determining an average number of times that the subscriber purchased prepaid credits over the predetermined time period to generate a subscriber average refill value; and
assigning the subscriber to a maximum amount tier in a plurality of maximum amount tiers, based at least in part on the subscriber account age value, the subscriber average consumption value, and the subscriber average refill value.

22. The at least one non-transitory computer-readable medium of claim 21, wherein determining a maximum amount of prepaid credit that the subscriber is eligible to be advanced based on an assessment of historical data relating to the subscriber account further comprises:
determining an amount of time that has passed since the subscriber last purchased prepaid credits to generate a subscriber inactivity value; and
assigning the subscriber to a maximum amount tier in a plurality of maximum amount tiers, based at least in part on the subscriber account age value, the subscriber average consumption value, the subscriber average refill value, and the subscriber inactivity value.

23. The at least one non-transitory computer-readable medium of claim 19, wherein historical data relating to the subscriber account comprises at least one of subscriber advance repayment history, subscriber prepaid credit purchase history, subscriber prepaid credit usage history, and subscriber registration.

24. The at least one non-transitory computer-readable medium of claim 19, further comprising additional instructions that, when executed by one or more computing devices, cause at least one of the one or more computing devices to:
determine whether a recovery-initiating event has occurred;
determine an amount of prepaid credit that is currently owed by the subscriber based at least in part on a determination that a recovery-initiating event has occurred;
determine an amount of prepaid credit that is currently in the subscriber account based at least in part on a determination that a recovery-initiating event has occurred and that the amount of prepaid credit that is currently owed by the subscriber is greater than zero; and
authorize a transfer of prepaid credit from the subscriber account to the lender account based at least in part on a determination that a recovery-initiating event has occurred, that the amount of prepaid credit that is currently owed by the subscriber is greater than zero, and that the amount of prepaid credit that is currently in the subscriber account is greater than zero.

25. The at least one non-transitory computer-readable medium of claim 24, wherein determining whether a recovery-initiating event has occurred comprises:
receiving an activity log relating to the subscriber account with the prepaid service provider;
determining whether additional prepaid credit has been added to the subscriber account based on the activity log; and
determining that a recovery-initiating event has occurred based at least in part on a determination that additional prepaid credit has been added to the subscriber account.

26. The at least one non-transitory computer-readable medium of claim 24, wherein determining whether a recovery-initiating event has occurred comprises:
determining a period of time that has passed since the transfer of prepaid credit from the lender account to the subscriber account; and
determining that a recovery-initiating event has occurred based on an assessment that the period of time that has passed since the transfer of prepaid credit from the lender account to the subscriber account is greater than a grace period for the subscriber, wherein the grace period for the subscriber is determined based on historical data relating to the subscriber account.

27. The at least one non-transitory computer-readable medium of claim 26, wherein the grace period is determined by:
extracting subscriber activity data from activity logs relating to the subscriber account with the service provider;
determining a pattern of prepaid credit additions from the subscriber activity data; and
calculating the grace period based at least in part on the pattern of prepaid credit additions.
